(19) United States
(12) Patent Application Publication
(10) Pub. No.: US 2019/0082232 A1
(43) Pub. Date: Mar. 14, 2019

(54) DEVICES, SYSTEMS AND METHODS FOR SELECTING ENRICHMENT DATA OF VIDEO CONTENT ITEMS BASED ON COMMERCIAL CONTENT OF THE VIDEO CONTENT ITEMS

(71) Applicant: COMIGO LTD., Yarkona (IL)

(72) Inventor: Amir EILAT, Tel Aviv (IL)

(21) Appl. No.: 16/120,972

(22) Filed: Sep. 4, 2018

Related U.S. Application Data
(60) Provisional application No. 62/556,467, filed on Sep. 10, 2017.

(51) Int. Cl. H04N 21/81; H04N 21/845; H04N 21/234; H04N 21/482

(52) U.S. Cl. CPC H04N 21/812; H04N 21/482; H04N 21/23424; H04N 21/8456

(57) ABSTRACT

Methods, devices, and systems for presenting enrichment data of video content items on a display device functionally associated with a client terminal, including displaying on the display device a video content item including one or more intervals of non-commercial video content and one or more intervals of commercial video content, and playing on the display device enrichment data of the video content item that is related to non-commercial content included in at least one interval of non-commercial video content, which enrichment data is identified as a candidate for enrichment data of the video content item based on commercial content included in at least one interval of commercial video content.

### RELATED APPLICATION

The present application gains priority from U.S. Provisional Patent Application 62/556,467 filed Sep. 10, 2017, and entitled “Selecting Enrichment Data According to a Commercial”, which is incorporated herein by reference as if fully set forth herein.

### FIELD AND BACKGROUND OF THE INVENTION

The invention, in some embodiments, relates to displaying of one or more video content items, and more particularly to methods and systems for selecting enrichment data of video content items based on one or more segments of commercial content included the video content items.

When television (TV) technology first became commercially available to the public, users could only consume video content at their homes under fixed, pre-determined, schedules and in a linear way. In other words, a user could only watch a movie or a news program at the time a broadcaster decided to broadcast it, and no deviation from the pre-defined program guide was possible. The only flexibility a user had was the selection of the channel that will be displayed on the user's TV screen, thus selecting between multiple video content items that are aired at a given time.

At a later stage, Video-On-Demand (VOD) was offered to users. This service enables users to consume content not appearing on the current programs schedule, resulting in a significant increase in flexibility when deciding what to watch. Another boost in user flexibility was achieved when TV operators introduced Catch-Up TV services which not only allow a user to pick any program recently offered in the EPG (Electronic Program Guide), but also allow him to jump backward and forward in time within a specific program and to pause and resume the playing of a program.

The next step in the process of increasing user flexibility was reached when some advanced Set-Top Boxes (STBs) started offering means for users to ask for enrichment data of video content they are currently watching. Enrichment data may include many different types of data which enhance content being watched, such as sport statistics related to a game currently watched by the requesting user, a picture of a person whose name is mentioned in the audio channel of content currently being watched (e.g. during a news program), textual information related to a person seen in the visual channel of content currently being watched, a list of links to related video content items that are connected to content currently being watched (from which list the user may select an item he wants to watch), a list of the main actors appearing in the content currently being watched, accompanied by their pictures, and the like.

When a user indicates his desire to receive enrichment data, for example by pressing a button on a remote controller device or by selecting a button on the screen using a pointing device, the enrichment data (or a list of optional enrichment data items) is displayed on the screen. The user's request may explicitly indicate the type of enrichment data in which the user is interested. For example, a menu or remote controller may include a button dedicated to requesting sport statistics. Alternatively, the request may be general. For example, the user may ask for any enrichment data, or for enrichment data that is related to the actors of the content currently being watched. In such cases, the system displays links to multiple enrichment items, letting the user choose a desired enrichment item from the list.

Content providers and operators insert commercial advertisements, or ads, into media content provided to users. Thus, a user that selected to watch a specific episode of the Simpsons TV series may see 7 minutes of the episode, then 2 minutes of commercials, then 7 more minutes of the episode, 2 more minutes of commercials, and finally the 8 last minutes of the episode.

In current TV systems, when an STB presents or proposes to a user enrichment data while watching video content, such as a TV-series episode, the displayed or proposed enrichment data is related to the episode as a whole, to a portion of the episode, or to a specific entity appearing in the episode (such as a person or place appearing in the episode). No enrichment data related to a commercial or to an entity appearing in a commercial is displayed or proposed. Thus, the feature of displaying or recommending enrichment data during a TV episode or a movie does not provide any benefit to the advertisers paying for the commercials shown during the TV episode or during the movie.

Methods for dynamically determining enrichment data to be displayed to a user are disclosed in U.S. Patent Application Publication Nos. 2018/0176660, 2012/0183229, 2016/0127759, and 2016/0119691, all of which are incorporated by reference, for all purposes, as if fully set forth herein.

There is thus a need in the art for a method and a system for selecting enrichment data based on commercial content played during video content currently being watched.

### SUMMARY OF THE INVENTION

Some embodiments of the invention relate to displaying of video content, and more particularly to methods and systems for selecting enrichment data of video content items based on one or more segments of commercial content included in the video content items.

According to an aspect of some embodiments of the invention, there is provided a method for presenting enrichment data of video content items on a display device functionally associated with a client terminal, including:
a. displaying on the display device, by the client terminal, a video content item, wherein the video content item includes one or more intervals of non-commercial video content and one or more intervals of commercial video content; and
b. playing on the display device, by the client terminal, enrichment data of the video content item that is related to non-commercial content included in at least one of the one or more intervals of non-commercial video content of the video content item, wherein the played enrichment data is identified as a candidate for enrichment data that may be played based on commercial content included in at least one of the one or more intervals of the commercial video content of the video content item.

In some embodiments, the method further includes, prior to the playing of the enrichment data, identifying one or more candidates for enrichment data of the video content item that are related to the non-commercial content, wherein, for at least one of the one or more candidates for enrichment data, the identifying is being based on corresponding commercial content included in at least one of the one or more intervals of the commercial video content, and wherein the played enrichment data is included in the at least one of the one or more candidates for enrichment data of the video content item.

In some embodiments, the identifying of the at least one of the one or more candidates for enrichment data is carried out during the displaying of the video content item.

In some embodiments, the identifying of the at least one of the one or more candidates for enrichment data is carried out by the client terminal.

In some embodiments, the identifying of the at least one of the one or more candidates for enrichment data is carried out by a server in communication with the client terminal.

In some embodiments, at least a portion of the playing of the enrichment data is carried out simultaneously with the displaying of the video content item. In some embodiments, the at least a portion of the playing of the enrichment data is carried out simultaneously with displaying of at least one of the one or more intervals of non-commercial video content. In some embodiments, the at least a portion of the playing of the enrichment data is carried out simultaneously with displaying of the at least one of the one or more intervals of commercial video content.

In some embodiments, the playing of the enrichment data is carried out while the displaying of the video content item is paused.

In some embodiments, the playing of the enrichment data is carried out subsequent to the displaying of the video content item.

In some embodiments, the played enrichment data includes video data. In some embodiments, the played enrichment data includes an audio clip. In some embodiments, the played enrichment data includes textual data. In some embodiments, the played enrichment data includes a still picture. In some embodiments, the played enrichment data includes a graphic animation.

In some embodiments, the method further includes:
c. prior to the playing of the enrichment data, receiving, by the client terminal, a request from a user to recommend one or more candidates for enrichment data of the video content item; and
d. subsequent to the receiving of the request, displaying, by the client terminal, one or more recommendations of one or more candidates for enrichment data of the video content item.

In some such embodiments, the method further includes:
e. subsequent to the displaying the one or more recommendations of one or more candidates for enrichment data, receiving, by the client terminal, a user selection of one of the one or more recommended candidates for enrichment data, wherein the played enrichment data is determined by the user selection.

In some embodiments, the method further includes:
c. prior to the playing of the enrichment data, displaying, by the client terminal, one or more recommendations of one or more candidates for enrichment data of the video content item.

In some such embodiments, the method further includes:
d. subsequent to the displaying the one or more recommendations of one or more candidates for enrichment data, receiving, by the client terminal, a user selection of one of the one or more recommended candidates for enrichment data, wherein the played enrichment data is determined by the user selection.

In some embodiments, the method further includes:
c. prior to the playing of the enrichment data, receiving, by the client terminal, a request from a user for enrichment data of the video content item, wherein the playing of the enrichment data is in automatic response to the receiving of the request.

In some embodiments, the client terminal includes a Set-Top Box. In some embodiments, the client terminal includes a smart TV.

According to an aspect of some embodiments of the invention, there is provided a device for presenting enrichment data of video content items on a display device functionally associated with the device, the device including:
a. a processor in communication with the display device; and
b. a non-transitory computer readable storage medium for instructions execution by the processor, the non-transitory computer readable storage medium having stored:
   i. first instructions, that when executed by the processor, display on the display device a video content item, wherein the video content item includes one or more intervals of non-commercial video content and one or more intervals of commercial video content; and
   ii. second instructions, that when executed by the processor, play on the display device enrichment data of the video content item that is related to non-commercial content included in at least one of the one or more intervals of non-commercial video content of the video content item, wherein the played enrichment data is identified as a candidate for enrichment data that may be played based on commercial content included in at least one of the one or more intervals of the commercial video content of the video content item.

In some embodiments, the non-transitory computer readable storage medium further has stored third instructions, to be executed prior to execution of the second instructions, that when executed by the processor, identify one or more candidates for enrichment data of the video content item that are related to the non-commercial content, wherein, for at least one of the one or more candidates for enrichment data, the identification is based on corresponding commercial content included in at least one of the one or more intervals of the commercial video content, wherein the enrichment data played when the processor executes the second instructions is included in the at least one of the one or more candidates for enrichment data of the video content item.

In some embodiments, the third instructions are to be executed during execution of the first instructions.

In some embodiments, the device forms part of a client terminal, such that the third instructions are to be carried out by the client terminal.

In some embodiments, the processor is adapted to execute at least a portion of the second instructions simultaneously with execution of the first instructions. In some embodiments, the processor is adapted to execute the at least a portion of the second instructions simultaneously with displaying at least one of the one or more intervals of non-commercial video content by the execution of the first instructions. In some embodiments, the processor is adapted to execute the at least a portion of the second instructions simultaneously with displaying at least one of the one or more intervals of commercial video content by the execution of the first instructions.

In some embodiments, the processor is adapted to execute at least a portion of the second instructions while execution of the first instructions is paused.

In some embodiments, the processor is adapted to execute at least a portion of the second instructions subsequent to execution of the first instructions.

In some embodiments, the enrichment data played when the processor executes the second instructions, includes video data. In some embodiments, the enrichment data played when the processor executes the second instructions, includes an audio clip. In some embodiments, the enrichment data played when the processor executes the second instructions, includes textual data. In some embodiments, the enrichment data played when the processor executes the second instructions, includes a still picture. In some embodiments, the enrichment data played when the processor executes the second instructions, includes a graphic animation.

In some embodiments, the non-transitory computer readable storage medium further has stored:
iii. third instructions to be executed prior to execution of the second instructions, that when executed by the processor, receive a request from a user to recommend one or more candidates for enrichment data of the video content item; and
iv. fourth instructions, to be executed subsequent to execution of the third instructions, that when executed by the processor, display one or more recommendations of one or more candidates for enrichment data of the video content item.

In some such embodiments, the non-transitory computer readable storage medium further has stored:
v. fifth instructions to be executed subsequent to execution of the fourth instructions, that when executed by the processor, receive a user selection of one of the one or more recommended candidates for enrichment data, wherein the enrichment data played when the processor executes the second instructions, is determined by the user selection.

In some embodiments, the non-transitory computer readable storage medium further has stored:
iii. third instructions, to be executed prior to execution of the second instructions, that when executed by the processor, display one or more recommendations of one or more candidates for enrichment data of the video content item.

In some such embodiments, the non-transitory computer readable storage medium further has stored:
iv. fourth instructions to be executed subsequent to execution of the third instructions, that when executed by the processor, receive a user selection of one of the one or more recommended candidates for enrichment data, wherein the enrichment data played when the processor executes the second instructions is determined by the user selection.

In some embodiments, the non-transitory computer readable storage medium further has stored:
iii. third instructions, to be executed prior to execution of the second instructions, that when executed by the processor, receive a request from a user for enrichment data of the video content item, wherein execution of the second instructions is in automatic response to execution of the third instructions.

In some embodiments, the device includes a Set-Top Box. In some embodiments, the device includes a smart TV.

According to an aspect of some embodiments of the invention, there is provided a system for presenting enrichment data of video content items on a display device functionally associated with the system, the system including:
a. the device as presented hereinabove, in communication with the display device; and
b. a server in communication with the device, the server including:
   i. a second processor; and
   ii. a second non-transitory computer readable storage medium for instructions execution by the second processor, the second non-transitory computer readable storage medium having stored third instructions, to be executed prior to execution of the second instructions stored in the computer readable storage medium of the device, that when executed by the second processor, identify one or more candidates for enrichment data of the video content item that are related to the non-commercial content, wherein, for at least one of the one or more candidates for enrichment data, the identification is based on corresponding commercial content included in at least one of the one or more intervals of the commercial video content, and wherein the enrichment data played when the processor of the device executes the second instructions is included in the at least one of the one or more candidates for enrichment data of the video content item.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1A is a schematic block diagram of an embodiment of a device for selecting enrichment data based on commercial video content according to embodiments of the teachings herein;

FIG. 1B is a schematic block diagram of an embodiment of a system for selecting enrichment data based on commercial video content according to embodiments of the teachings herein;

FIG. 2 is a flow chart of an embodiment of a method for selecting enrichment data based on commercial video content according to embodiments of the teachings herein.

### DESCRIPTION OF SOME EMBODIMENTS OF THE INVENTION

It is a goal of the present invention to take advantage of the enrichment data feature for enhancing the effectivity of commercials played during a program. This is achieved by adding the content of commercial(s) played during the program to the factors affecting the selection of enrichment data that is proposed and/or played to the user.

Consider the example of the Simpsons TV series mentioned above in the Background section. Suppose a commercial for a bowling center is played during the episode. If the user asks for related video content, when providing the user with a list of recommendations of related video content items, the list provided by the system may include a recommendation to watch the Simpsons episode “Life on the Fast Lane”. This recommended episode is related to the program currently being watched by being another episode of the Simpsons TV series, and is also related to the played commercial because bowling is prominently featured in the “Life on the Fast Lane” episode. Therefore, including this episode in a list of proposed enrichment data serves the interests of the advertiser of the bowling center—if the user selects this recommendation and watches “Life on the Fast Lane”, then he is going to be thinking about bowling for the next 26 minutes. Therefore the probability that the user will decide to visit the advertised bowling center may be significantly increased.

As another example, suppose one of the commercials played during the time that the user watches the Simpsons episode is a promotion video for a Britney Spears concert. If the user asks for related video content, when providing the user with a list of recommendations of related video content the system may include in the list a recommendation to watch the Simpsons episode “The Mansion Family”. This recommended episode is related to the program currently being watched by being another episode of the Simpsons TV series, and is also related to the commercial because Britney Spears appears in the “The Mansion Family” episode and even plays her own role in it. Therefore, including “The Mansion Family” in a list of proposed enrichment content serves the interests of the Britney Spears concert advertiser—if the user selects this recommendation and watches “The Mansion Family”, then he is going to be reminded of Britney Spears. Therefore, the probability that the user will decide to buy a ticket to the advertised concert may be increased.

As another example, suppose the user is watching an NBA basketball game between the Golden State Warriors and the Cleveland Cavaliers, and one of the commercials played during the game is for promoting Nike® sports shoes. If the user asks for game statistics enrichment data, when providing the user with the players' statistics during times in which non-Nike-commercial content is played, the displayed stats table includes columns containing number of points scored, number of 2-point shots, number of 3-point shots, percentage of hits, etc., for each participating player. However, when providing the statistics table during the time in which the Nike-commercial content is played, the displayed stats table includes an additional column showing, for each player, whether he uses Nike® shoes in the current season, and for how many years of his career he has been using Nike® shoes. Including this extra information in the stats table serves the interests of the advertiser (Nike®)—when the user studies the statistics table he requested, he will be reminded of the fact that famous and successful NBA players use Nike® shoes. Therefore, the probability that the user will decide to buy Nike® shoes is increased.

In an alternative embodiment of the last example, the second form of the stats table, which includes columns relating to the players' use of Nike® shoes, is always used when displaying an NBA game in which the Nike® commercial will be displayed, regardless of whether or not the commercial is currently being displayed. The first form of the stats table, which does not include the Nike® related columns, is used only when displaying NBA games in which the Nike® commercial is not included.

In still another example, suppose the program being watched is a program about worldwide air travel. During the program, the user is given an option to ask for enrichment data elaborating about generic safety procedures in international airlines, which are common to all international airlines. Suppose further, that the system is configured to operate in an automatic enrichment data selection mode, so that when a user requests enrichment data, the program is paused and relevant enrichment data is automatically selected and played, without requiring, or enabling receipt of, further input from the user. In a first broadcast of the program, a Delta Airlines commercial is played. In this case, once the user requests the display of the safety procedures enrichment data during the program, the system automatically pauses the program, and plays a video clip, in which the plane used for demonstrating the safety procedures is a Delta plane. During a rerun of the program, a Lufthansa commercial is played. In this case, once the user requests the safety procedures enrichment data during the program, the system automatically pauses the program and plays a video clip, in which the plane used for demonstrating the safety procedures is a Lufthansa plane. As the system does not know in advance what airline commercial will be played during a specific broadcast of the program (if any), the determination of the specific version of the safety procedures video to be displayed is carried out in real-time, while the program is being played.

It is appreciated that, at least in some cases, it may be undesirable for the proposed enrichment data to be related only to the commercial content and not to the true (non-commercial) content of the currently playing media content item. If the proposed enrichment data were related only to the commercial content, the user might become frustrated by the system trying to influence him in the interests of the advertiser, while ignoring the fact that the reason he is asking for the enrichment data is in order to receive additional content related to the true content of the program he is currently watching, or has just finished watching. The user becoming frustrated with ad-influenced enrichment data might have an effect opposite than the desired effect—instead of visiting the advertised bowling center, the user might develop negative feelings about it and might decide to never visit it, even when he will eventually want to play the game.

Implementations of the proposed solution may require an ability to identify when commercials are being played. Methods for identification of commercials are well known in the art, and any method for achieving this task may be used in implementing the proposed solution. Examples of such methods are disclosed in U.S. Pat. Nos. 6,100,941, 7,170,566, 6,285,818, 7,110,658, and US Application Publication No. 2003/0123841, all of which are incorporated herein by reference in their entirety.

Similarly, implementations of the proposed solution may require an ability to recognize and disambiguate named entities mentioned, or referred to, in a commercial. Methods for Named Entity Recognition (NER) and Named Entity Disambiguation (NED) are well known in the art, and any method for achieving these tasks may be used in implementing the proposed solution. Examples of such methods are disclosed in U.S. Pat. No. 7,171,350, 9,190,055, 9,135,238, 7,685,201, US Application Publication No. 2009/0249182, US Application Publication No. 2014/0163951, and US Application Publication No. 2015/0286629, all of which are incorporated herein by reference in their entirety.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the examples. The invention can be implemented with other embodiments and can be practiced or carried out in various ways. It is also understood that the phraseology and terminology employed herein is for descriptive purpose and should not be regarded as limiting.

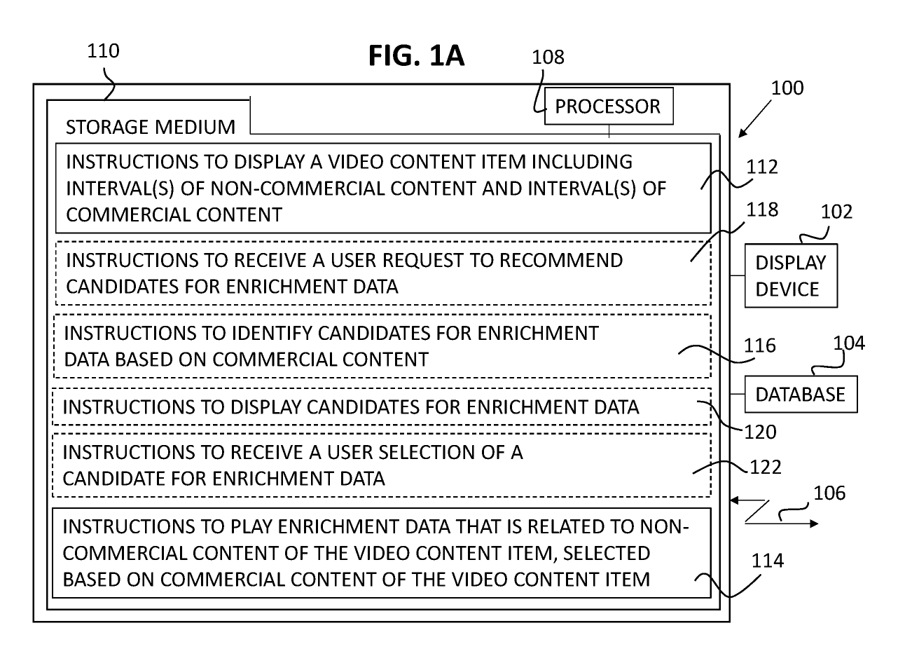

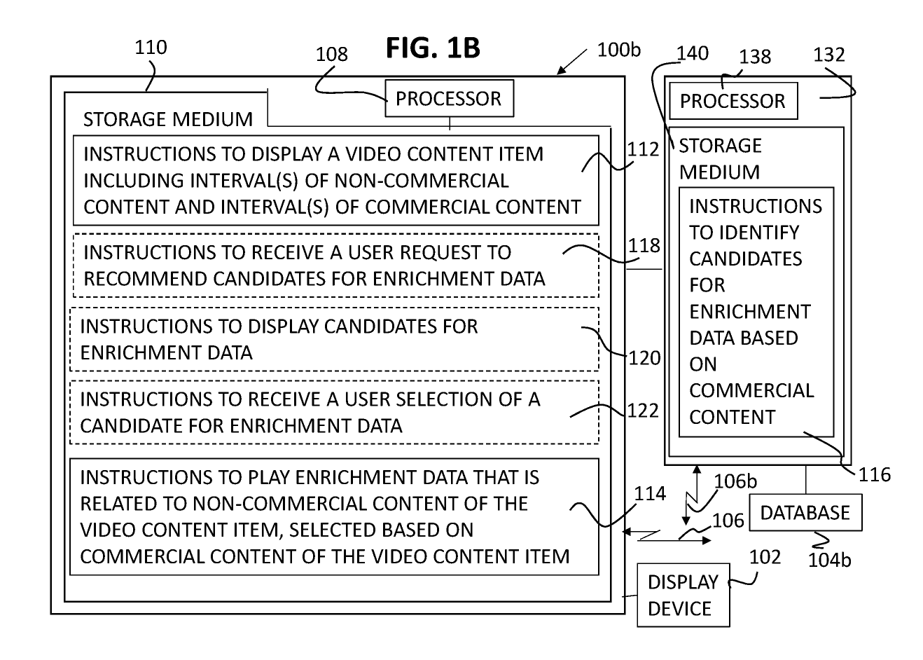

Reference is now made to FIG. 1A, which is a schematic block diagram of an embodiment of a device for selecting enrichment data based on commercial video content according to embodiments of the teachings herein.

As seen in FIG. 1A, a device 100 for selecting enrichment data based on commercial video content is functionally associated with a display device 102. The display device may be any suitable display device, such as a television screen, a computer screen, a projector projecting video content onto a wall or a pull-down projector screen, and the like.

In some embodiments, the device 100 may be, or may include, a Set-Top Box. In some embodiments, the device 100 may be, or may include, a smart TV, in which case display device 102 may be the screen of the smart TV.

In some embodiments, device 100 may be functionally associated with one or more databases 104 including content suitable for providing as enrichment data, such as a database of sports statistics suitable for providing as enrichment content, a database including biographical information and images of actors and actresses, a video clip database, and the like. In some embodiments, device 100 may be connected to, or form part of, a network which can be searched for enrichment data, such as the Internet, as indicated by arrow 106.

Device 100 includes a processor 108 and a storage medium 110, which is typically a non-transitory computer readable storage medium.

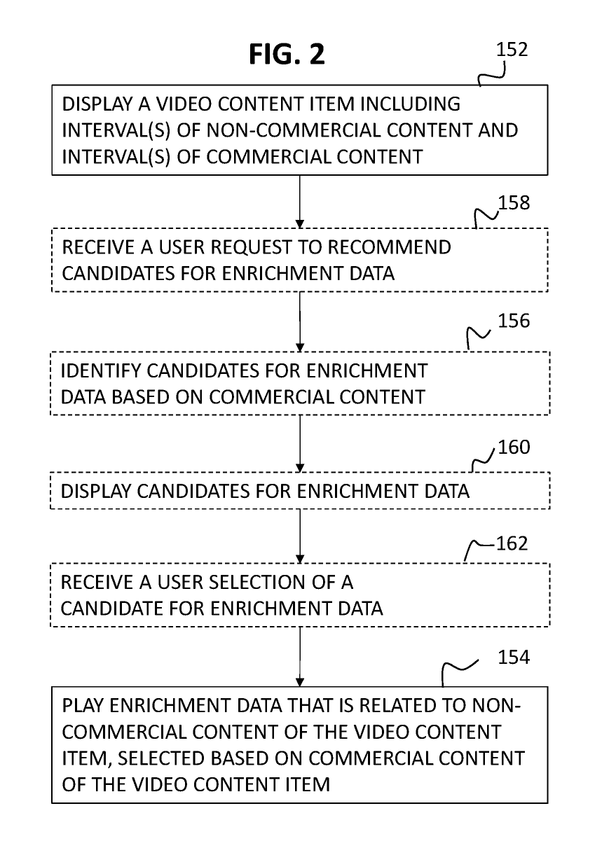

The storage medium 110 includes instructions to be executed by the processor 108, in order to carry out various steps of the method described herein below with respect to FIG. 2. Specifically, the storage medium includes the following instructions:

instructions 112, that when executed by processor 108, display on display device 102 a video content item, which video content item includes one or more intervals of non-commercial video content and one or more intervals of commercial video content; and

instructions 114, that when executed by processor 108, play on display device 102 enrichment data of the video content item, which enrichment data is related to non-commercial video content included in at least one of the non-commercial video content intervals, and is identified as a candidate for enrichment data based on commercial video content included in at least one of the commercial video content intervals.

In some embodiments, the processor 108 executes at least a portion of the instructions 114 simultaneously with execution of the instructions 112. Stated differently, in some embodiments, at least a portion of the enrichment data of the video content item is played simultaneously with displaying of the video content item. In some embodiments, at least a portion of the enrichment data is played simultaneously with displaying at least one interval of non-commercial video content of the video content item. In some embodiments, at least a portion of the enrichment data is played simultaneously with displaying at least one interval of commercial video content of the video content item.

In some embodiments, the processor 108 executes at least a portion of the instructions 114 while execution of the instructions 112 is paused. Stated differently, in some embodiments, at least a portion of the enrichment data of the video content item is played while displaying of the video content item is paused.

In some embodiments, the processor 108 executes at least a portion of the instructions 114 subsequent to execution of the instructions 112. Stated differently, in some embodiments, at least a portion of the enrichment data of the video content item is played subsequent to completion of displaying of the video content item.

The enrichment data played when instructions 114 are executed by processor 108, may be any suitable type of enrichment data, and may include video data, an audio clip, textual data, a still picture, and/or a graphic animation.

In some embodiments, storage medium 110 further has stored instructions 116, that when executed by processor 108, identify one or more candidates for enrichment data of the video content item that are related to the non-commercial video content, where the identification is based on corresponding commercial video content included in at least one interval of the commercial video content intervals. The one or more candidates for enrichment data that are identified based on commercial video content may be all of the candidates, or may be only a portion of the list of candidates. The instructions 116 are adapted to be executed prior to execution of instructions 114, such that the enrichment data played when processor 108 executes the instructions 114 is included in the one or more identified candidates for enrichment data that are identified based on commercial video content of the video content item.

In some embodiments, the processor 108 executes the instructions 116 during execution of the instructions 112. Stated differently, in some embodiments, candidates for enrichment data of the video content item are identified during displaying of the video content item.

In some embodiments, storage medium 110 further has stored instructions 118, that when executed by processor 108, receive a request from a user to recommend one or more candidates for enrichment data of the video content item. The instructions 118 are adapted to be executed prior to execution of instructions 114.

In embodiments in which storage medium 110 includes instructions 116, the instructions 118 may be executed prior to execution of instructions 116, such that candidates for enrichment data are identified only after the user has requested enrichment data, or may be executed following execution of instructions 116, such that candidates for enrichment data are identified regardless of the user wishing to receive enrichment data.

In some embodiments, instructions 114 are executed by processor 108 in automatic response to execution of instructions 118. Stated differently, following receipt of a user request for recommended candidates for enrichment data, processor 108 automatically plays selected enrichment data, which is automatically selected by the processor.

In some embodiments, the automatic selection of the enrichment data to be played by the processor may be random selection from a list of identified candidates for enrichment data.

In some embodiments, the automatic selection of the enrichment data to be played by the processor may be based on a metric measuring the strength of the connection between the enrichment data and the commercial content and/or the non-commercial content of the video content item.

In some embodiments, the automatic selection of the enrichment data to be played by the processor may be based on user preferences, such as previous user choices, information in a user profile, and explicit user feedback.

In some embodiments, storage medium 110 further has stored instructions 120, that when executed by processor 108, display one or more recommendations of one or more candidates for enrichment data of the video content item, on display device 102.

Typically, the instruction 120 are executed by processor 108 following execution of instructions 116. Stated differently, first the candidates for enrichment data are identified by execution of instructions 116, and subsequently the recommendations of such candidates are displayed to the user.

In some embodiments, the instructions 120 are executed by processor 108 following execution of instructions 118, and prior to execution of instructions 114. Stated differently, in some embodiments, recommendations of candidates for enrichment data of the video content item are displayed to the user on display device 102 after the user has requested to see enrichment data, and prior to playing the enrichment data.

In other embodiments, the user need not necessarily explicitly request to see enrichment data, and the device may automatically offer a list of recommended candidates for enrichment data. In such embodiments, instructions 118 would be obviated, and instructions 120 would be executed prior to execution of instructions 114.

In some embodiments, storage medium 110 further has stored instructions 122, that when executed by processor 108, receive a user selection of one of the recommended candidates for enrichment data. The processor 108 is adapted to execute instructions 122 following execution of instructions 120 and prior to execution of instructions 114, such that the enrichment data played when processor 108 executes instructions 114 is determined by the received user selection.

As such, there may be four different alternatives for operation of the processor with respect to providing candidates for enrichment data and selection of enrichment data to be played, as listed hereinbelow:
1. The user manually requests candidates for enrichment data, a list of candidates for enrichment data are displayed to the user, and the user manually selects the enrichment data to be played.
2. There is not user request for candidates for enrichment data, but when a list of such candidates is displayed to the user, the user manually selects the enrichment data to be played.
3. The user manually requests candidates for enrichment data, and in response the processor automatically selects the enrichment data to be played, and automatically plays the selected enrichment data.
4. The system is fully automatic, in that the user does not request candidates for enrichment data, and the processor automatically selects the enrichment data to be played and automatically plays the selected enrichment data.

Turning now to FIG. 1B, which is a schematic block diagram of an embodiment of a system for selecting enrichment data based on commercial video content according to embodiments of the teachings herein, it is seen that the system of FIG. 1B includes device 100b, substantially similar to device 100 of FIG. 1A, functionally associated with a display device 102 as in FIG. 1A.

FIGS. 1A and 1B differ in that the system of FIG. 1B further includes a server 132, functionally associated with device 100b, which includes a second processor 138 and a second a storage medium 140, which is typically a non-transitory computer readable storage medium. In the system of FIG. 1B, instructions 116 are stored in second storage medium 140 for execution by second processor 138. Instructions 112, and 114, and optional instructions 118, 120, and 122, remain stored in storage medium 110 for execution by processor 108 of device 100b.

Due to the fact that in FIG. 1B identification of candidate enrichment data is carried out by server 132 and not by device 100b, in some embodiments, the one or more databases 104b are functionally associated with server 132, in addition to, or instead of, being functionally associated with device 100b. In some embodiments, server 132 is connected to a network, such as the Internet, by network connection 106b, in addition to device 100b being connected to the network by network connection 106.

A method for selecting enrichment data based on commercial video content according to embodiments of the teachings herein, using the device and system of FIGS. 1A and 1B, is now described with respect to FIG. 2.

As seen, at step 152, processor 108 of device 100 executes instructions 112, and displays on display device 102 a video content item which includes one or more intervals of non-commercial video content and one or more intervals of commercial video content.

At step 154, processor 108 executes instructions 114 and plays on display device 102 enrichment data of the video content item that is related to non-commercial video content of the video content item, which enrichment data is identified as a candidate for enrichment data, that may be played at step 154, based on commercial video content of the video content item.

The enrichment data played at step 154 may be any suitable enrichment data, and may include video data, an audio clip, textual data, a still picture, and/or a graphic animation.

In some embodiments, at least a portion of step 154 is carried out simultaneously with step 152, such that there is a time overlap between displaying the video content item and playing the enrichment data on display device 102. In some embodiments, the time overlap occurs during at least one interval of non-commercial video content of the video content item. In some embodiments, the time overlap occurs during at least one interval of commercial video content of the video content item.

In some embodiments, playing of the enrichment data at step 154 is carried out while displaying of the video content item at step 152 is paused.

In some embodiments, playing of the enrichment data at step 154 is carried out subsequent to displaying of the video content item at step 152, such as when displaying of the video content item is completed.

In some embodiments, the method further includes step 156, in which one or more candidates for enrichment data of the video content item that are related to the non-commercial video content are identified, based on corresponding commercial video content included in at least one interval of commercial video content intervals of the video content item. The one or more candidates for enrichment data that are identified based on commercial video content may be all of the candidates, or may be only a portion of the list of candidates. In some embodiments, step 156 is carried out by processor 108 executing instructions 116 stored on storage medium 110 of device 100. In other embodiments, step 156 is carried out by processor 138 carrying out instructions 116 stored on storage medium 140 of server 132.

As illustrated in FIG. 2, step 156 is carried out prior to step 154, such that the enrichment data played when carrying out step 154 is included in the one or more candidates for enrichment data identified in step 156 that are identified based on commercial video content of the video content item.

In some embodiments, identification of candidates for enrichment data at step 156 occurs during displaying of the video content item at step 152.

In some embodiments, the method further includes step 158, in which processor 108 executes instructions 118 and receives a request from a user to recommend one or more candidates for enrichment data of the video content item. The request is received prior to playing the enrichment data at step 154.

In some embodiments, the user request of step 158 is received prior to identification of candidates for enrichment data at step 156, such that candidates for enrichment data are identified only after the user has requested enrichment data. In other embodiments, the candidates for enrichment data may be identified regardless of the user's desire to receive enrichment data, such that identification of enrichment data at step 156 occurs prior to receipt of the user request at step 158.

In some embodiments, enrichment data is played by step 154 in automatic response to receipt of a user request for enrichment data at step 158. In such embodiments, the enrichment data may be automatically selected by the processor.

In some embodiments, the enrichment data is automatically selected by the processor by random selection from a list of identified candidates for enrichment data.

In some embodiments, the enrichment data is automatically selected by the processor based on a metric measuring the strength of the connection between the enrichment data and the commercial content and/or the non-commercial content of the video content item.

In some embodiments, the enrichment data is automatically selected by the processor based on user preferences, such as previous user choices, information in a user profile, and explicit user feedback.

In some embodiments, the method further includes step 160, in which processor 108 executes instructions 120 and displays one or more recommendations of one or more candidates for enrichment data of the video content item, on display device 102.

Typically, the recommendations are displayed at step 160 following identification of candidates for enrichment data at step 156.

In some embodiments, the recommendations of candidates for enrichment data of the video content item are displayed at step 160 after the user has requested to see enrichment data at step 158, and prior to playing the enrichment data at step 154.

In other embodiments, the user need not necessarily explicitly request to see enrichment data, and the device may automatically offer a list of recommended candidates for enrichment data. In such embodiments, step 158 would be obviated.

In some embodiments, the method further includes step 162, in which processor 108 executes instructions 122 and receives a user selection of one of the recommended candidates for enrichment data. The receipt of a user selection of one of the recommended candidates for enrichment data at step 162 occurs following displaying of recommendations of candidates for enrichment data at step 160, and prior to playing of the enrichment data at step 154, such that the enrichment data played at step 154 is determined by the user selection received at step 162.

### Definitions

This disclosure, including the description of the invention and the claims, should be interpreted according to the definitions below.

In case of a contradiction between the definitions provided herein and other sections of this disclosure, these definitions should prevail.

In case of a contradiction between the definitions provided herein and a definition or a description in any other document, including in another document included in this disclosure by reference, these definitions should prevail, even if the definition or the description in the other document is commonly accepted by a person of ordinary skill in the art.
a. “media content item”—a stand-alone unit of media content that can be referred to and identified by a single reference and can be played independently of other content. For example, a movie, a TV program, an episode of a TV series, a video clip, an animation, an audio clip, or a still image.
   A media content item may include only non-commercial media content, or alternatively it may include both non-commercial media content and commercial media content. In the second case, the commercial media content may be an integral part of the media content item, or it may be dynamically inserted into the media content item on its way from its provider to a visual/audio output device which plays it. Thus, a media content item may include different commercial content in different events of being played.
b. “video content item”—a media content item that contains a visual track viewable on a screen. A video content item may or may not additionally contain an audio track. A still image is a special case of a video content item.
   A video content item may include only non-commercial video content, or alternatively it may include both non-commercial video content and commercial video content.
c. “audio content item”—a media content item that contains only an audio track audible using a speaker or headphones, but does not contain a visual track. An audio content item may include only non-commercial audio content, or alternatively it may include non-commercial audio content and commercial audio content.
d. “audio” and “aural” are used as synonyms herein.
e. “video” and “visual” are used as synonyms herein.
f. “audio channel” and “audio track” are used as synonyms herein. Both refer to an audio component of a media content item.
g. “video channel” and “video track” are used as synonyms herein. Both refer to a video component of a media content item. A still image is a special case of video track.
h. “commercial media content”—Media content that is an advertisement intended for promoting or selling a product, a service or an idea.
i. “commercial video content”—Video content that is an advertisement intended for promoting or selling a product, a service or an idea.
“commercial audio content”—Audio content that is an advertisement intended for promoting or selling a product, a service or an idea.
k. “true media content” or “non-commercial media content”—Media content that is not commercial media content.
l. “true video content” or “non-commercial video content”—Video content that is not commercial video content.
m. “true audio content” or “non-commercial audio content”—Audio content that is not commercial audio content.
n. “graphic animation”—video content including animation which is generated solely by computer, without use of a camera or another imaging device.
o. “enrichment data of a media content item”—Data that is related in some way to the media content item. For example, a table of sport statistics related to a team participating in a sporting event that is being shown in the media content item, a still picture of a person which is shown or mentioned in the media content item, an audio clip adding information about a term mentioned in the media content item, a graphic animation adding explanations about a term mentioned in the media content item, and a video clip providing information about an actor appearing in the media content item. Any combination of different types of enrichment data of a media content item is also enrichment data of the media content item.
p. “visual enrichment data of a media content item”—Enrichment data of the media content item that includes a visual channel.
q. “a type of enrichment data”—An attribute of enrichment data that is related to its form. The type is one of textual data, graphic animation, video data, still picture, audio clip and any combination thereof.
r. “media playing device”—a device that is capable of playing a media content item. For example, an audio-only player that is capable of playing an audio content item, a video-only player that is capable of playing a video content item, a combined video/audio player that is capable of playing both the video channel and the audio channel of a media content item in parallel.
s. “VOD” or “Video On Demand”—A service which allows users to select and watch video content items such as movies and TV shows when they choose to, rather than having to watch at a specific broadcast time.
t. “playing media content”—outputting at least one of a video channel and an audio channel of the media content to a visual output device (for example a TV screen) or to an audio output device (for example a speaker or headphones). If the media content is a still image, then playing it means outputting the still image to a visual output device. If the media content is video content that has both a video channel and an audio channel, then playing it means outputting both the video channel and the audio channel to a visual output device and to an audio output device, respectively. Pausing a video content item in the middle of playing is considered playing the video content item. Also, showing the last frame of a video content item after it was played to its end is considered playing the video content item.
u. “displaying media content”—outputting a video channel of the media content to a visual output device (for example a TV screen). If the media content is a still image, then displaying it means outputting the still image to a visual output device. If the media content is video content that has both a video channel and an audio channel, then the displaying may optionally also include outputting the audio channel to an audio output device. Pausing a video content item in the middle of playing it is considered displaying the video content item. Also, showing the last frame of a video content item after it was played to its end is considered displaying the video content item.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for presenting enrichment data of video content items on a display device functionally associated with a client terminal, comprising:
a. displaying on the display device, by the client terminal, a video content item, wherein said video content item includes one or more intervals of non-commercial video content and one or more intervals of commercial video content; and
b. playing on the display device, by the client terminal, enrichment data of the video content item that is related to non-commercial content included in at least one of said one or more intervals of non-commercial video content of said video content item, wherein said played enrichment data is identified as a candidate for enrichment data that may be played based on commercial content included in at least one of said one or more intervals of said commercial video content of said video content item.

2. The method of claim 1, further comprising, prior to said playing of said enrichment data, identifying one or more candidates for enrichment data of said video content item that are related to said non-commercial content, wherein, for at least one of said one or more candidates for enrichment data, said identifying is being based on corresponding commercial content included in at least one of said one or more intervals of said commercial video content, and wherein said played enrichment data is included in said at least one of said one or more candidates for enrichment data of said video content item.

3. The method of claim 2, wherein said identifying of said at least one of said one or more candidates for enrichment data is carried out during said displaying of said video content item.

4. The method of claim 2, wherein said identifying of said at least one of said one or more candidates for enrichment data is carried out by the client terminal.

5. The method of claim 2, wherein said identifying of said at least one of said one or more candidates for enrichment data is carried out by a server in communication with the client terminal.

6. The method of claim 1, wherein at least a portion of said playing of said enrichment data is carried out simultaneously with the displaying of the video content item.

7. The method of claim 6, wherein said at least a portion of said playing of said enrichment data is carried out simultaneously with displaying of at least one of said one or more intervals of non-commercial video content.

8. The method of claim 6, wherein said at least a portion of said playing of said enrichment data is carried out simultaneously with displaying of said at least one of said one or more intervals of commercial video content.

9. The method of claim 1, wherein said playing of said enrichment data is carried out while the displaying of said video content item is paused.

10. The method of claim 1, wherein said playing of said enrichment data is carried out subsequent to said displaying of said video content item.

11. The method of claim 1, wherein said played enrichment data includes at least one of video data, an audio clip, textual data, a still picture, or a graphic animation.

12. The method of claim 1, further comprising:
c. prior to said playing of said enrichment data, receiving, by the client terminal, a request from a user to recommend one or more candidates for enrichment data of said video content item; and
d. subsequent to said receiving of said request, displaying, by the client terminal, one or more recommendations of one or more candidates for enrichment data of said video content item.

13. The method of claim 12, further comprising:
e. subsequent to said displaying said one or more recommendations of one or more candidates for enrichment data, receiving, by the client terminal, a user selection of one of said one or more recommended candidates for enrichment data, wherein said played enrichment data is determined by said user selection.

14. The method of claim 1, further comprising:
c. prior to said playing of said enrichment data, displaying, by the client terminal, one or more recommendations of one or more candidates for enrichment data of said video content item.

15. The method of claim 14, further comprising:
d. subsequent to said displaying said one or more recommendations of one or more candidates for enrichment data, receiving, by the client terminal, a user selection of one of said one or more recommended candidates for enrichment data, wherein said played enrichment data is determined by said user selection.

16. The method of claim 1, further comprising:
c. prior to said playing of said enrichment data, receiving, by the client terminal, a request from a user for enrichment data of said video content item, wherein said playing of said enrichment data is in automatic response to said receiving of said request.

17. A device for presenting enrichment data of video content items on a display device functionally associated with the device, the device comprising:
a. a processor in communication with the display device; and
b. a non-transitory computer readable storage medium for instructions execution by the processor, the non-transitory computer readable storage medium having stored:
i. first instructions, that when executed by said processor, display on the display device a video content item, wherein said video content item includes one or more intervals of non-commercial video content and one or more intervals of commercial video content; and
ii. second instructions, that when executed by said processor, play on the display device enrichment data of the video content item that is related to non-commercial content included in at least one of said one or more intervals of non-commercial video content of said video content item, wherein said played enrichment data is identified as a candidate for enrichment data that may be played based on commercial content included in at least one of said one or more intervals of said commercial video content of said video content item.

18. The device of claim 17, said non-transitory computer readable storage medium further having stored third instructions, to be executed prior to execution of said second instructions, that when executed by said processor, identify one or more candidates for enrichment data of said video content item that are related to said non-commercial content, wherein, for at least one of said one or more candidates for enrichment data, said identification is based on corresponding commercial content included in at least one of said one or more intervals of said commercial video content,
wherein said enrichment data played when said processor executes said second instructions is included in said at least one of said one or more candidates for enrichment data of said video content item.

19. The device of claim 18, wherein said third instructions are to be executed during execution of said first instructions.

20. A system for presenting enrichment data of video content items on a display device functionally associated with the system, the system comprising:
a. the device according to claim 17, in communication with said display device; and
b. a server in communication with said device, said server including:
i. a second processor; and
ii. a second non-transitory computer readable storage medium for instructions execution by the second processor, said second non-transitory computer readable storage medium having stored third instructions, to be executed prior to execution of said second instructions stored in said computer readable storage medium of said device, that when executed by said second processor, identify one or more candidates for enrichment data of said video content item that are related to said non-commercial content, wherein, for at least one of said one or more candidates for enrichment data, said identification is based on corresponding commercial content included in at least one of said one or more intervals of said commercial video content, and wherein said enrichment data played when said processor of said device executes said second instructions is included in said at least one of said one or more candidates for enrichment data of said video content item.
